(19) United States
(12) Patent Application Publication
(10) Pub. No.: US 2020/0049117 A1
(43) Pub. Date: Feb. 13, 2020

(54) HIGH-PRESSURE FUEL PUMP

(71) Applicant: TOYOTA JIDOSHA KABUSHIKI KAISHA, Toyota-shi (JP)

(72) Inventor: Kazuhiro ASAYAMA, Nagoya-shi (JP)

(73) Assignee: TOYOTA JIDOSHA KABUSHIKI KAISHA, Toyota-shi (JP)

(21) Appl. No.: 16/507,397

(22) Filed: Jul. 10, 2019

(30) Foreign Application Priority Data
Aug. 9, 2018 (JP) 2018-150350

(51) Int. Cl. F02M 59/46; F02M 39/00; F02M 59/02

(52) U.S. Cl. CPC F02M 59/466; F02M 59/02; F02M 39/005

(57) ABSTRACT

A high-pressure fuel pump includes a fuel chamber, a pressurizing chamber, a cylinder, a plunger, and a control valve. The control valve includes a valve seat having a valve hole, a valve member, a movable portion having a needle, a valve opening spring, a coil, and a projecting-side stopper. The needle is configured to project from the valve hole and thus separate the valve member from the valve seat. When the control valve is in an open-valve mode, the movable portion contacts the projecting-side stopper and the valve member is separate from the valve seat. The size of the clearance formed between the valve member and the valve seat when the control valve is in the open-valve mode is set such that the clearance functions as a passage restriction for causing pressure loss in the fuel flowing from the pressurizing chamber to the fuel chamber.

### BACKGROUND

### 1. Field

The present disclosure relates to a high-pressure fuel pump that draws in, pressurizes, and discharges fuel.

### 2. Description of Related Art

Japanese Laid-Open Patent Publication No. 2014-222029 discloses a fuel supply device including a high-pressure fuel pump. A feed pump pumps fuel from a fuel tank and discharges the fuel into a low-pressure fuel passage. The high-pressure fuel pump draws in the fuel from the low-pressure fuel passage into a pressurizing chamber. A plunger in the high-pressure fuel pump reciprocates in a cylinder to change the volume of the pressurizing chamber. This pressurizes the fuel in the pressurizing chamber and discharges the fuel from the pressurizing chamber. The high-pressure fuel pump includes a suction valve to selectively open and close a suction port of the pressurizing chamber. If the plunger is driven when the suction valve is open, fuel returns from the pressurizing chamber of the high-pressure fuel pump into the low-pressure fuel passage, thus causing pulsation. The pulsation is transmitted from the high-pressure fuel pump to the low-pressure fuel passage. To decrease such pulsation, the fuel supply device described in the aforementioned document includes a restriction in the low-pressure fuel passage to cause pressure loss in the fuel passing through the restriction.

The pressure loss occurs when the fuel passes through the restriction, which is provided to decrease the pulsation. Therefore, if the restriction is disposed in the low-pressure fuel passage as disclosed in the aforementioned document, the pressure loss caused by the restriction limits the flow velocity, thus raising the pressure in the region upstream of the restriction. This makes it necessary to ensure rigidity in the low-pressure fuel passage, even though the pressure of the fuel flowing in the low-pressure fuel passage is lower than the pressure of the fuel in the high-pressure fuel passage.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a high-pressure fuel pump is provided that includes a fuel chamber, a pressurizing chamber, a cylinder, a plunger, and a control valve. The fuel chamber is configured to draw in fuel after the fuel is pumped from a fuel tank by a feed pump. The pressurizing chamber is configured such that the fuel flows from the fuel chamber into the pressurizing chamber. The cylinder defines a section of the pressurizing chamber. The plunger reciprocates in the cylinder and is configured to change the volume of the pressurizing chamber by reciprocating, thereby pressurizing the fuel in the pressurizing chamber and discharging the fuel from the pressurizing chamber. The control valve includes a valve seat, a valve member, a movable portion, a valve opening spring, a coil, and a projecting-side stopper. The valve seat has a valve hole that allows the fuel chamber and the pressurizing chamber to be continuous with each other. The valve member is configured to become seated on the valve seat to block the valve hole when moving from the pressurizing chamber toward the fuel chamber. The movable portion has a needle configured to project from the valve hole toward the pressurizing chamber to separate the valve member from the valve seat. The valve opening spring urges the movable portion in a direction of projecting the needle from the valve hole. The coil is configured to generate a magnetic flux that attracts the movable portion against the urging force of the valve opening spring, thereby causing the valve member to contact the valve seat. The projecting-side stopper is configured to contact the movable portion and thus restrict movement of the movable portion in the direction of projecting the needle from the valve hole, thereby limiting a projecting length of the needle from the valve hole. When the control valve is in an open-valve mode, the movable portion contacts the projecting-side stopper and the valve member is separate from the valve seat. A size of a clearance formed between the valve member and the valve seat when the control valve is in the open-valve mode is set such that the clearance functions as a passage restriction for causing pressure loss in the fuel flowing from the pressurizing chamber to the fuel chamber.

Other features and aspects will be apparent from the following detailed description, the drawings, and the claims.

### BRIEF DESCRIPTION OF THE DRAWINGS

FIG. 1 is a diagram schematically showing the configuration of a fuel supply device including a high-pressure fuel pump according to an embodiment.

FIG. 2 is a cross-sectional view of the high-pressure fuel pump of FIG. 1.

FIG. 3 is a cross-sectional view of the vicinity of a control valve in the high-pressure fuel pump of FIG. 1.

FIG. 4 is a cross-sectional view showing the control valve in a closed-valve mode in the high-pressure fuel pump of FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

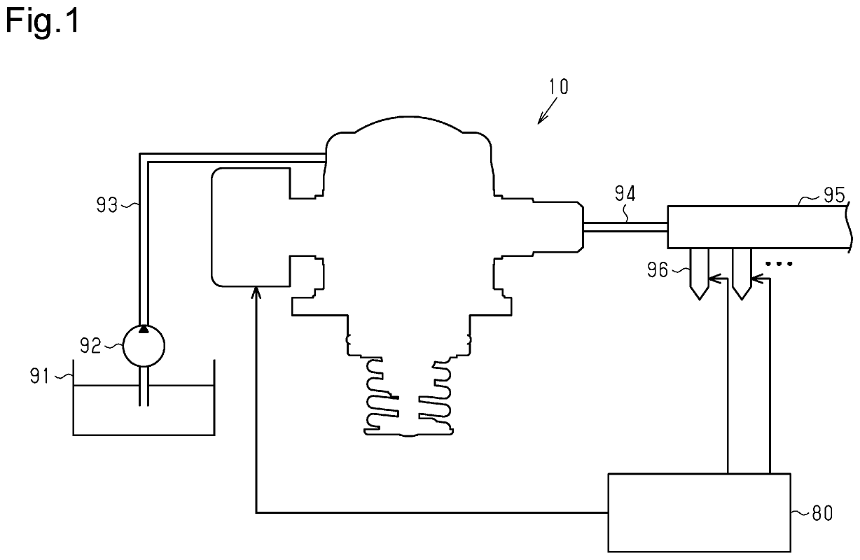

A high-pressure fuel pump 10 according to an embodiment will now be described with reference to FIGS. 1 to 4.

FIG. 1 shows a fuel supply device for an internal combustion engine, including the high-pressure fuel pump 10. The fuel supply device includes a feed pump 92 to pump fuel from a fuel tank 91, where the fuel is retained. After pumping the fuel from the fuel tank 91, the feed pump 92 discharges the fuel into a low-pressure fuel passage 93. The high-pressure fuel pump 10 is connected to the low-pressure fuel passage 93. The high-pressure fuel pump 10 draws in the fuel from the low-pressure fuel passage 93 and pressurizes and discharges the fuel into a high-pressure fuel passage 94. The high-pressure fuel pump 10 is driven by, for example, the rotational force of a camshaft of the engine. A high-pressure delivery pipe 95 is connected to the high-pressure fuel passage 94. Fuel injection valves 96 are connected to the high-pressure delivery pipe 95. After being discharged from the high-pressure fuel pump 10, the fuel is supplied to the fuel injection valves 96 via the high-pressure delivery pipe 95. The fuel supply device also includes a control unit 80 to control the driving of the fuel injection valves 96 and the driving of the high-pressure fuel pump 10.

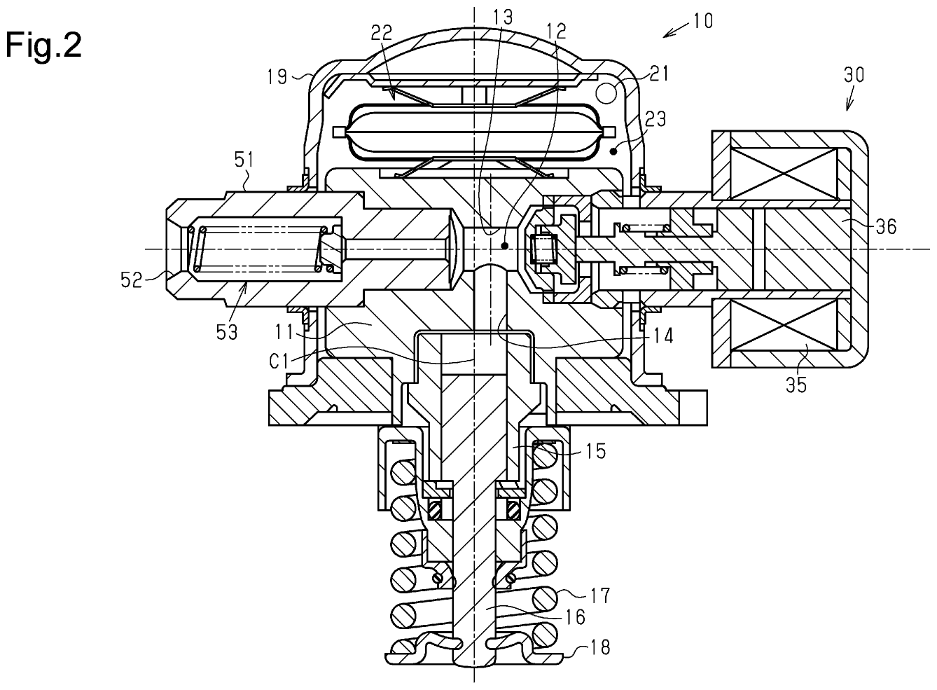

As shown in FIG. 2, the high-pressure fuel pump 10 includes an external housing member 19 and an internal housing member 11. The internal housing member 11 is accommodated in the external housing member 19. The high-pressure fuel pump 10 includes a fuel chamber 23 as the space defined by the external housing member 19. A pulsation damper 22 is arranged in the fuel chamber 23 and has an elastically deformable diaphragm. The external housing member 19 has a suction port 21 to allow fuel to flow between the low-pressure fuel passage 93 and the fuel chamber 23.

The high-pressure fuel pump 10 includes a cylinder 15 and a plunger 16. The plunger 16 is capable of reciprocating in the cylinder 15. FIG. 2 shows the first axis C1 extending in the movement direction of the plunger 16. A driving spring 17 urges the plunger 16 in a direction of projecting from the cylinder 15. A plate 18 is disposed on the end of the plunger 16 opposite to the end accommodated in the cylinder 15. When force is transmitted from a cam to the plunger 16 via the plate 18, the plunger 16 is displaced in a direction of being accommodated in the cylinder 15.

The high-pressure fuel pump 10 includes a pressurizing chamber 12 and fuel flows from the fuel chamber 23 into the pressurizing chamber 12. The pressurizing chamber 12 includes a space defined by the internal housing member 11 and a space defined by the cylinder 15 and the plunger 16. The internal housing member 11 has a first chamber 14 extending parallel to the first axis C1. The internal housing member 11 also has a second chamber 13, which is continuous with the first chamber 14. The second chamber 13 extends orthogonally to the first axis C1. The space defined by the cylinder 15 and the plunger 16 is continuous with the second chamber 13 through the first chamber 14. The first chamber 14 is a cylindrical space with a diameter smaller than the diameter of the space defined by the cylinder 15 and the plunger 16.

The high-pressure fuel pump 10 includes a control valve 30. The control valve 30 is capable of blocking the connection between the fuel chamber 23 and the pressurizing chamber 12. The control unit 80, as illustrated in FIG. 1, controls the control valve 30. The control valve 30 includes a coil 35. The control unit 80 energizes and de-energizes the coil 35 in a switching manner, thus changing a control mode of the control valve 30. The control modes of the control valve 30 include a closed-valve mode, in which the connection between the fuel chamber 23 and the pressurizing chamber 12 is blocked, and an open-valve mode, in which such connection is permitted.

The high-pressure fuel pump 10 includes a cylindrical discharge-side housing member 51 having a distal end projecting from the external housing member 19. The discharge-side housing member 51 includes a discharge port 52 to discharge fuel from the pressurizing chamber 12. More specifically, the discharge port 52 opens in the distal end of the discharge-side housing member 51. The proximal end of the discharge-side housing member 51 is passed through a through hole in the external housing member 19 and thus arranged in the external housing member 19. The proximal end of the discharge-side housing member 51 is attached to the internal housing member 11. A check valve 53 is disposed in the discharge-side housing member 51. The check valve 53 is configured to open when the pressure in the pressurizing chamber 12 becomes greater than or equal to a predetermined valve opening pressure.

As the plunger 16 moves in the direction in which the plunger 16 projects from the cylinder 15, the volume of the pressurizing chamber 12 increases. As the plunger 16 moves in the direction in which the plunger 16 is accommodated in the cylinder 15, the volume of the pressurizing chamber 12 decreases.

If the volume of the pressurizing chamber 12 decreases when the connection between the fuel chamber 23 and the pressurizing chamber 12 is blocked, the fuel in the pressurizing chamber 12 is pressurized and discharged into the high-pressure fuel passage 94. If the volume of the pressurizing chamber 12 increases when the aforementioned connection is permitted, fuel may be drawn in from the low-pressure fuel passage 93 to the fuel chamber 23 or introduced from the fuel chamber 23 into the pressurizing chamber 12. If the volume of the pressurizing chamber 12 decreases when the connection between the fuel chamber 23 and the pressurizing chamber 12 is permitted, fuel is returned from the pressurizing chamber 12 to the fuel chamber 23 and then from the fuel chamber 23 into the low-pressure fuel passage 93.

The control valve 30 will now be described with reference to FIGS. 2 to 4.

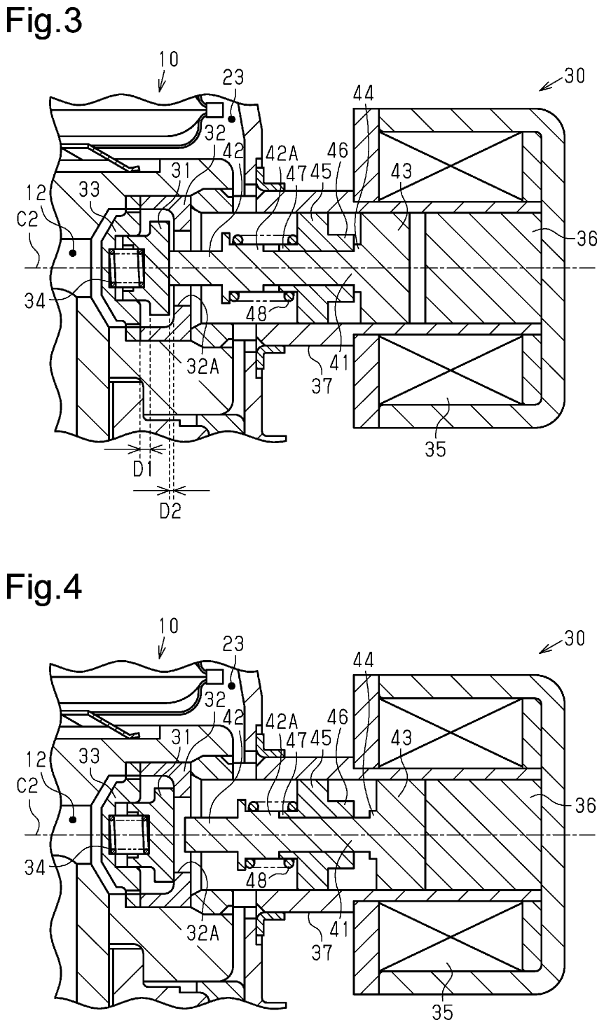

With reference to FIG. 3, the control valve 30 includes a valve seat 32. The valve seat 32 has a valve hole 32A to allow the fuel chamber 23 and the pressurizing chamber 12 to be continuous with each other. The control valve 30 includes a valve member 31. The valve member 31 is configured to become seated on the valve seat 32 and thus block the valve hole 32A when moving from the pressurizing chamber 12 toward the fuel chamber 23. When the valve member 31 is seated on the valve seat 32, as shown in FIG. 4, the connection between the fuel chamber 23 and the pressurizing chamber 12 is blocked. If the valve member 31 is separate from the valve seat 32, as illustrated in FIG. 3, the fuel chamber 23 is continuous with the pressurizing chamber 12. The control valve 30 includes a valve stopper 33 between the pressurizing chamber 12 and the valve member 31. The valve member 31 is configured to contact the valve stopper 33 when moving from the fuel chamber 23 toward the pressurizing chamber 12. The valve stopper 33 has a through hole through which fuel flows. The valve member 31 is accommodated in the space surrounded by the valve seat 32 and the valve stopper 33. A valve closing spring 34 is attached to the valve stopper 33 to urge the valve member 31 in the direction toward the valve seat 32.

The control valve 30 includes a cylindrical control-valve housing member 37. The control-valve housing member 37 has a first end. The first end is passed through a through hole in the external housing member 19, arranged in the external housing member 19, and attached to the internal housing member 11. A movable portion 41 is accommodated in the control-valve housing member 37 and is movable in the control-valve housing member 37. The control-valve housing member 37 has a second end (the end opposite to the external housing member 19). A fixed core 36 is arranged on the second end of the control-valve housing member 37. A coil 35 is disposed around the fixed core 36.

The movable portion 41 includes a movable core 43. When the coil 35 is energized and generates magnetic flux, the movable core 43 is attracted to the fixed core 36.

The movable portion 41 includes a needle 42 integrated with the movable core 43. The distal end of the needle 42 is configured to contact the valve member 31 by projecting from the valve hole 32A of the valve seat 32 toward the pressurizing chamber 12. FIGS. 2 and 3 show the distal end of the needle 42 projecting from the valve hole 32A of the valve seat 32 and contacting the valve member 31. The movable core 43 has an end surface facing the valve seat 32 and the needle 42 extends from the end surface toward the valve seat 32. FIG. 3 shows a second axis C2 as a line extending along the axis of the needle 42. The direction in which the second axis C2 extends is the direction in which the movable portion 41 moves. The needle 42 has a radially extended stepped portion 44 in the proximal end section of the needle 42 that is connected to the movable core 43.

A needle seat 45 having a central hole is fixed to the inner peripheral surface of the control-valve housing member 37. In other words, the control-valve housing member 37 accommodates the needle seat 45. The section of the needle 42 extending from the stepped portion 44 toward the distal end of the needle 42 is slidably inserted through the central hole of the needle seat 45. A valve opening spring 48 is attached to the needle seat 45 and urges the movable portion 41 in a direction in which the needle 42 projects from the valve hole 32A. The direction in which the distal end of the needle 42 projects from the valve hole 32A toward the valve member 31 is the valve opening direction. The opposite direction to the valve opening direction is the valve closing direction. The needle seat 45 holds the needle 42 slidably in the control-valve housing member 37. The needle seat 45 has a body fixed to the control-valve housing member 37 and a projecting-side stopper 46. The projecting-side stopper 46 restricts movement of the movable portion 41 in the valve opening direction. The projecting-side stopper 46 has a smaller diameter than the body. The projecting-side stopper 46 extends from the body of the needle seat 45 toward the fixed core 36.

When the coil 35 is not energized, the valve opening spring 48 urges the movable portion 41 so that the distal end of the needle 42 projects from the valve hole 32A of the valve seat 32 toward the valve member 31. The diameter of the central hole of the needle seat 45 is smaller than the diameter of the outer circumference of the stepped portion 44. When the needle 42 projects from the valve hole 32A of the valve seat 32 and contacts the valve member 31, as illustrated in FIG. 3, the stepped portion 44 of the movable portion 41 contacts the projecting-side stopper 46. The open-valve mode of the control valve 30 is the state in which the coil 35 is not energized and the projecting-side stopper 46 contacts the stepped portion 44. In this state, the needle 42 projects from the valve hole 32A and contacts the valve member 31. The movable portion 41 is urged by the valve opening spring 48 in the valve opening direction and thus presses the valve member 31, against the urging force produced by the valve closing spring 34, in a direction of separating the valve member 31 from the valve seat 32. The projecting length of the needle 42 from the valve hole 32A in the open-valve mode has been set, at the time of designing the high-pressure fuel pump 10, by adjusting the length of the projecting-side stopper 46 of the needle seat 45 along the second axis C2 and the length of the stepped portion 44 of the movable portion 41 along the second axis C2. In other words, the projecting length of the needle 42 is limited by restricting movement of the movable portion 41 in the valve opening direction to a certain range by means of the projecting-side stopper 46 and the stepped portion 44. When the control valve 30 is in the open-valve mode, fuel may flow in the valve closing direction, which is from the pressurizing chamber 12 toward the fuel chamber 23, such that force acts on the valve member 31 in the valve closing direction toward the valve seat 32. Even in this case, the valve opening spring 48 urges the movable portion 41 in the valve opening direction, thus projecting the needle 42 from the valve hole 32A to maintain the valve member 31 without becoming seated on the valve seat 32.

FIG. 3 shows a first clearance D1 at the time the needle 42 contacts the valve member 31 and the valve member 31 is separate from the valve seat 32 in the open-valve mode. The first clearance D1 is the clearance between the valve stopper 33 and the valve member 31. The drawing also shows a second clearance D2 at the time the needle 42 contacts the valve member 31 and the valve member 31 is separate from the valve seat 32 in the open-valve mode. The second clearance D2 is the clearance between the valve member 31 and the valve seat 32. The second clearance D2 is equal to the projecting length of the needle 42 from the valve hole 32A. Specifically, the first clearance D1 and the second clearance D2 are illustrated simply schematically in FIG. 3 and thus do not represent the actual sizes. The size of the second clearance D2 is set such that the second clearance D2 functions as a passage restriction for causing pressure loss in the fuel flowing from the pressurizing chamber 12 to the fuel chamber 23. If the size of the clearance between the valve member 31 and the valve seat 32 in the state in which the valve member 31 contacts the valve stopper 33 is defined as X, for example, the size of the second clearance D2 may be set approximately to a value in the range of X/10 to X/100.

FIG. 4 shows the control valve 30 at the time the coil 35 is energized. When the coil 35 is energized, magnetic flux is generated and attracts the movable core 43 to the fixed core 36 against the urging force of the valve opening spring 48. In other words, force by which the movable portion 41 is moved toward the fixed core 36, which is in the valve closing direction, is produced. The needle seat 45 includes an accommodating-side stopper 47 with a diameter smaller than the diameter of the projecting-side stopper 46. The accommodating-side stopper 47 projects toward the valve seat 32 from the surface of the body opposite to the projecting-side stopper 46. The needle 42 also has an engagement portion 42A between the distal end of the needle 42 and the accommodating-side stopper 47. The valve opening spring 48 has a first end and a second end. The first end is attached to the engagement portion 42A and the second end is attached to the needle seat 45. The engagement portion 42A has a greater diameter than the distal end of the needle 42, as well as the section inserted through the central hole of the needle seat 45. When the movable core 43 is attracted to the fixed core 36, the engagement portion 42A of the needle 42 contacts the accommodating-side stopper 47, thus restricting movement of the movable portion 41 toward the fixed core 36 (in the valve closing direction). The closed-valve mode of the control valve 30 represents energizing the coil 35 to cause contact between the accommodating-side stopper 47 and the engagement portion 42A. In this state, the needle 42 is maintained without projecting from the valve hole 32A toward the pressurizing chamber 12. The valve member 31 thus becomes seated on the valve seat 32 by receiving urging force from the valve closing spring 34. In this state, the needle 42 and the valve member 31 are separate from each other by a predetermined distance.

An operation and advantages of the present embodiment will now be described.

As shown in FIG. 3, when the control valve 30 is in the open-valve mode, the high-pressure fuel pump 10 of the present embodiment projects the needle 42 from the valve hole 32A toward the pressurizing chamber 12, thus forming the second clearance D2 between the valve member 31 and the valve seat 32. The second clearance D2 functions as a restriction for causing pressure loss in the fuel flowing from the pressurizing chamber 12 to the fuel chamber 23. In this manner, the fuel supply device decreases the pulsation caused by the fuel returning from the high-pressure fuel pump 10 into the low-pressure fuel passage 93. In other words, the pulsation transmitted from the high-pressure fuel pump 10 toward the feed pump 92 is decreased.

At the time of fuel discharge, the pressurized fuel applies high pressure to the region (the upstream region) in the fuel passage in the high-pressure fuel pump 10 closer to the pressurizing chamber 12 than the valve member 31. For this reason, the high-pressure fuel pump 10 has rigidity capable of tolerating a pressure rise in the upstream region when the pressure rise is caused by the pressure loss occurring in the fuel passing through the second clearance D2 as fuel flows from the pressurizing chamber 12 to the fuel chamber 23. In other words, unlike cases in which a restriction is disposed in the low-pressure fuel passage 93 to cause pressure loss and thus decrease pulsation, the restriction is arranged in a section that conventionally has rigidity. As a result, it is unnecessary to increase the rigidity to withstand the pressure loss.

In the present embodiment, when the control valve 30 is in the open-valve mode, the needle 42 projects from the valve hole 32A and presses the valve member 31, thus maintaining the clearance between the valve member 31 and the valve seat 32. Therefore, if the fuel returning from the pressurizing chamber 12 to the fuel chamber 23 applies force to the valve member 31 in the valve closing direction toward the valve seat 32, the size of the clearance between the valve member 31 and the valve seat 32 can be selectively reduced and enlarged, compared to the size of the second clearance D2. For example, the greater the flow velocity of the fuel returning from the pressurizing chamber 12 to the fuel chamber 23, the smaller the size of the clearance between the valve member 31 and the valve seat 32 becomes. By reducing the size of the clearance, the amount of pressure loss through the clearance is increased. In other words, as the size of the clearance between the valve member 31 and the valve seat 32 is repeatedly reduced and enlarged while fuel is flowing from the pressurizing chamber 12 to the fuel chamber 23, the amount of pressure loss is changed in correspondence with the flow velocity of the fuel. This decreases the pulsation transmitted from the high-pressure fuel pump 10 toward the feed pump 92.

With a different pump displacement, a high-pressure fuel pump will have a different flow velocity of fuel that returns from the pressurizing chamber to the fuel chamber. As has been described, in the present embodiment, the size of the clearance between the valve member 31 and the valve seat 32 is changed in correspondence with the flow velocity of fuel. Therefore, simply by setting the second clearance D2 based on the projecting length of the needle 42 from the valve hole 32A, the disclosure can be adapted to high-pressure fuel pumps with various pump displacements without setting the size of the restriction to a suitable value in correspondence with the pump displacement.

As a comparative example to the present embodiment, a restriction may be disposed in the low-pressure fuel passage 93. For example, an orifice plate having a hole of a desired size may be disposed in the low-pressure fuel passage 93. In this case, the amount of pressure loss in the fuel passing through the restriction varies depending on the size of the hole in the orifice plate. In contrast, in the present embodiment, the size of the second clearance D2 is determined based on the projecting length of the needle 42 from the valve hole 32A. In other words, the size of the clearance between the valve member 31 and the valve seat 32 at the time the control valve 30 is in the open-valve mode without any fuel flow is set in correspondence with the projecting length of the needle 42. As a result, a desired restriction for decreasing pulsation can be ensured by changing the projecting length of the needle 42. In other words, the size of the restriction can be set without machining the orifice plate or arranging the orifice plate in the low-pressure fuel passage 93.

In the present embodiment, when the control valve 30 is in the open-valve mode, the valve member 31 is separate from the valve stopper 33 and the first clearance D1 is formed between the valve member 31 and the valve stopper 33. In other words, the valve member 31 is permitted to move toward the pressurizing chamber 12. Therefore, when fuel flows from the fuel chamber 23 into the pressurizing chamber 12, the valve member 31 is pressed by the fuel in the valve opening direction separately from the valve seat 32 and thus allowed to move until the valve member 31 contacts the valve stopper 33. The closer the valve member 31 to the valve stopper 33, the greater the size of the clearance between the valve member 31 and the valve seat 32 becomes. When the valve member 31 contacts the valve stopper 33, the size of the clearance between the valve member 31 and the valve seat 32 is enlarged by the amount corresponding to the size of the first clearance D1. In this manner, the clearance between the valve member 31 and the valve seat 32 is caused to function as the restriction when fuel returns from the pressurizing chamber 12 to the fuel chamber 23. Also, when the fuel flows from the fuel chamber 23 into the pressurizing chamber 12, the clearance between the valve member 31 and the valve seat 32 is enlarged in size so as to ensure a necessary flow amount.

The above-described embodiment may be modified as follows. The above-described embodiment and the following modifications can be combined as long as the combined modifications remain technically consistent with each other.

Although the projecting-side stopper 46 is integrated with the needle seat 45 in the above-described embodiment, the projecting-side stopper 46 and the needle seat 45 may be separate components. As long as the projecting-side stopper 46 restricts movement of the movable portion 41 in the valve opening direction by contacting the movable portion 41, the projecting-side stopper 46 may or may not be integrated with the needle seat 45.

In the above-described embodiment, the projecting length of the needle 42 is set by adjusting the length of the stepped portion 44 and the length of the projecting-side stopper 46. However, the projecting length of the needle 42 may be set by adjusting the length of either the stepped portion 44 or the projecting-side stopper 46. The needle 42 thus may lack the stepped portion 44, for example. Alternatively, the needle seat 45 may lack the projecting-side stopper 46.

In the above-described embodiment, the projecting length of the needle 42 at the time the control valve 30 is in the open-valve mode without any fuel flow may be changed. The projecting length of the needle 42 can be changed by altering, for example, the length of the needle 42, the projecting-side stopper 46, or the stepped portion 44 along the second axis C2.

By altering the projecting length of the needle 42, the size of the clearance between the valve member 31 and the valve seat 32 at the time the control valve 30 is in the open-valve mode without any fuel flow is changed. In other words, the amount of pressure loss in the fuel passing through the aforementioned clearance is changed. This changes the range of pump displacement that can be dealt with.

The valve opening spring 48 may be changed to a spring that produces a different level of urging force. However, the urging force applied to the movable portion 41 by the valve opening spring 48 must be of such a level as to be capable of maintaining contact between the projecting-side stopper 46 and the stepped portion 44 when the coil 35 is not energized so that, even if the valve member 31 is urged toward the valve seat 32 by the fuel flowing from the pressurizing chamber 12 to the fuel chamber 23 in the open-valve mode of the control valve 30, the needle 42 can project from the valve hole 32A to maintain the valve member 31 without becoming seated on the valve seat 32. Although the size of the clearance between the valve member 31 and the valve seat 32 is varied by the fuel returning from the pressurizing chamber 12 to the fuel chamber 23 in the above-described embodiment, the range of such variation is determined by the urging force of the valve opening spring 48. The variation range of clearance size thus can be changed by altering the urging force of the valve opening spring 48, which is the force by which the movable portion 41 is urged in the valve opening direction. For example, the variation range of clearance size can be reduced by increasing the force by which the valve opening spring 48 urges the movable portion 41. Similarly, the variation range of clearance size can be changed by altering the urging force of the valve closing spring 34.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A high-pressure fuel pump comprising:
a fuel chamber that is configured to draw in fuel after the fuel is pumped from a fuel tank by a feed pump;
a pressurizing chamber that is configured such that the fuel flows from the fuel chamber into the pressurizing chamber;
a cylinder that defines a section of the pressurizing chamber;
a plunger that reciprocates in the cylinder and is configured to change the volume of the pressurizing chamber by reciprocating, thereby pressurizing the fuel in the pressurizing chamber and discharging the fuel from the pressurizing chamber; and
a control valve, wherein
the control valve includes
a valve seat having a valve hole that allows the fuel chamber and the pressurizing chamber to be continuous with each other,
a valve member that is configured to become seated on the valve seat to block the valve hole when moving from the pressurizing chamber toward the fuel chamber,
a movable portion that has a needle configured to project from the valve hole toward the pressurizing chamber to separate the valve member from the valve seat,
a valve opening spring that urges the movable portion in a direction of projecting the needle from the valve hole,
a coil that is configured to generate a magnetic flux that attracts the movable portion against the urging force of the valve opening spring, thereby causing the valve member to contact the valve seat, and
a projecting-side stopper that is configured to contact the movable portion and thus restrict movement of the movable portion in the direction of projecting the needle from the valve hole, thereby limiting a projecting length of the needle from the valve hole,
when the control valve is in an open-valve mode, the movable portion contacts the projecting-side stopper and the valve member is separate from the valve seat, and
a size of a clearance formed between the valve member and the valve seat when the control valve is in the open-valve mode is set such that the clearance functions as a passage restriction for causing pressure loss in the fuel flowing from the pressurizing chamber to the fuel chamber.

2. The high-pressure fuel pump according to claim 1, wherein
the control valve further includes
a valve stopper that is configured to contact the valve member, thereby restricting movement of the valve member in a direction of separating from the valve seat, and
a valve closing spring that urges the valve member in a direction toward the valve seat, and
when the control valve is in the open-valve mode, the valve member contacts the needle and is separate from the valve stopper in such a manner that the valve member is permitted to move toward the pressurizing chamber until the valve member becomes separate from the needle and contacts the valve stopper.

3. The high-pressure fuel pump according to claim 2, wherein
the size of the clearance between the valve member and the valve seat when the valve member contacts the valve stopper is X, and
the size of the clearance formed between the valve member and the valve seat when the control valve is in the open-valve mode is in a range of X/10 to X/100.

4. The high-pressure fuel pump according to claim 2, wherein
the direction of projecting the needle from the valve hole is a valve opening direction,
the movable portion has a movable core, wherein the movable core is attracted by the magnetic flux generated through energization of the coil, and
the movable core, the projecting-side stopper, the valve opening spring, the valve member, and the valve stopper are arranged sequentially in the valve opening direction.

5. The high-pressure fuel pump according to claim 4, wherein
the control valve further includes a needle seat having a central hole through which the needle is slidably inserted and a cylindrical control-valve housing member that accommodates the needle seat,
the needle seat has a body fixed to an inner peripheral surface of the control-valve housing member and the projecting-side stopper extending from the body toward the movable core, and
the projecting-side stopper has a smaller diameter than the body.

6. The high-pressure fuel pump according to claim 4, wherein
the needle has a radially extended stepped portion in a proximal end section of the needle that is connected to the movable core, and
the stepped portion is configured to contact the projecting-side stopper when the movable portion moves in the valve opening direction.
